(19) United States
(12) Patent Application Publication
(10) Pub. No.: US 2006/0283608 A1
(43) Pub. Date: Dec. 21, 2006

(54) Fire extinguisher activating a remote alarm

(76) Inventor: Curt A. Hauck, St. James, MS (US)

Correspondence Address: Curt A. Hauck, 17976 Highway 8, St. James, MS, 65559, US

(21) Appl. No.: 11/153,130

(22) Filed: Jun. 16, 2005

(51) Int. Cl. A62C 11/00; A62C 35/60; A62C 25/00; A62C 13/76; A62C 13/00; G08B 13/14

(52) U.S. Cl. 169/30; 169/23; 169/51; 169/75; 169/76; 340/571

(57) ABSTRACT

A fire extinguisher has a combination alarm system attached thereto or in contact therewith. The alarm is energized when a fire extinguisher is removed from any one location which sends a signal to a remote monitor to indicate such a removal. the alarm system also includes a signal which is generated when a fire extinguisher is used to douse a fire. The signal is generated when the trigger of the fire extinguisher is activated to expel the fire fighting fluid from the extinguisher. This signal is sent to the proper authority by way an RF transmitter.

### FIELD OF THE INVENTION

Fire extinguishers are known and are used in many environments such as in residences, high rise apartment buildings condos, restaurants and office buildings. They are also used and are present in cars, trucks and boats. Fire codes require that they are present in all of the above mentioned locations. The fire extinguishers are monitored frequently and on a regular basis to ensure that they are always in top operating condition.

### BACKGROUND OF THE INVENTION

All of the above mentioned locations have one drawback and that is that there is no indication when a fire extinguisher is being removed from any one location or when a fire extinguisher is being used unless some one calls the fire department or the 911 number. In many instances, when there is a fire, there is a certain panic or pandemonium, where nobody thinks about calling for help. There are some house monitoring agency operating to protect homes or residences. They have a monitoring unit installed in the residence that will monitor the doors, the windows against opening or breaking and they will monitor the fire alarm sensors that are mostly installed in the ceilings. If any unusual circumstance is detected, the monitoring unit will dial the company and they in turn will notify the respective Authorities. However, there is no monitoring system known that will notify respective authorities when a fire extinguisher is removed from any location or when a fire extinguisher is operated to douse a fire. It would be a great public service to have a safety system if any use of a fire extinguisher would immediately be known and if the use of a fire extinguisher would telegraph such a use to the proper authorities.

### BRIEF DESCRIPTION OF THE INVENTION

Apartment buildings, condominiums or high rise office buildings have a multiple of fire extinguishers ready for use with many installed on the same floor. As was mentioned above, all of the fire extinguishers are monitored on a regular basis with many of them having to be removed from a certain location for the purpose of having to refill or to retrofit the same. Quite often. fire extinguishers are removed by unauthorized persons or for unlawful use. Unless immediately observed, nobody would know such a removal. The inventive concept remedies the above noted problems by instantly telegraphing such removal to a central location such as the manager's or engineer's office including an indication of the exact location. If the exact location has been indicated and the fire extinguisher is used on a fire in an emergency, the use of the trigger or operating handle of the extinguisher is also submitted either to the manager or the fire department by radio signals. The exact location can be transmitted through the use of a geo-synchronous satellite system.

### BRIEF DESCRIPTION OF THE FIGS. OF THE DRAWINGS

FIG. 1 is a perspective view of a fire extinguisher transmitting radio signals when the safety pin is being removed;

FIG. 2 is a perspective view of a fire extinguisher transmitting radio signals when the trigger handle is being operated;

FIG. 3 shows a fire extinguisher support frame that is mounted on a wall wherein a push button switch on the bottom signals the removal of the extinguisher;

FIG. 4 illustrates a fire extinguisher installed in the support frame of FIG. 3;

FIG. 5 Shows a support frame for a fire extinguisher having a reflector sensor therein;

FIGS. 6A and 6B illustrate a fire extinguisher supported an a hinged bracket which will pivot when the extinguisher is removed therefrom to produce a signal;

FIG. 7 illustrates a signaling system by way of reflector and sensors built into the trigger handle of the extinguisher;

FIG. 8 shows a schematic electric system that monitors the presence of a multiple fire extinguishers in a building.

### DETAILED DESCRIPTION OF THE INVENTION

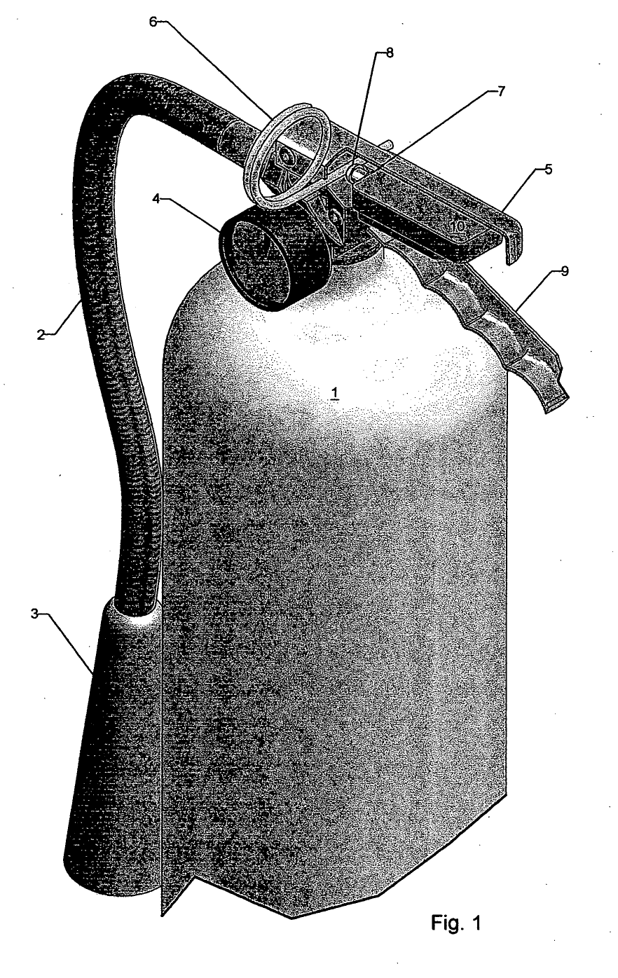

FIG. 1 shows a well known fire extinguisher as 1 having the hose 2 attached thereto with the hose carrying a nozzle 3 at an end thereof. This extinguisher 1 also shows the well known pressure gauge 4 thereon. The fire extinguisher 1 is carried by the carrying handle 9 or can be used to mount the fire extinguisher 1 on a bracket. The thus described features are present in all subsequent FIGS. and will not be repeated unless essential in the description of a particular figure. The fire extinguisher 1 is prevented from operating unless the safety pin 6 is removed therefrom. The removal of the safety pin is instrumental in triggering the alarm system on this particular fire extinguisher because it releases a spring biased plunger 8 which activates the switch 7 which in turn activates the RF transmitter module 10 which in turn sends a radio signal to the fire department. The trigger or operating handle 5 can be used to expel the fire depressant fluid from the extinguisher. The fire department can determine the exact location of that particular fire extinguisher in use because the RF transmitter module can be so configured to use the well known geo-synchronous satellite system. It is believed that a further detailed description of this system is not necessary because of its widespread use in automobiles, for example.

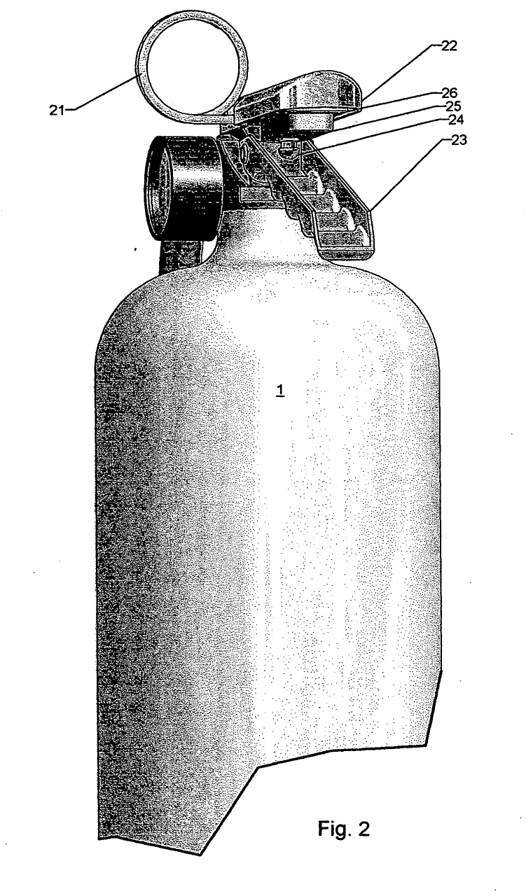

FIG. 2 illustrates a different mechanism for activating a radio signal. In this embodiment, the fire extinguisher signal is not activated by the removal of the safety pin 21 as was explained with reference to FIG. 1 but the signal is activated by the movement of the trigger handle 22 which will activate the spring biased plunger 24 when pushed downwardly and which in turn will activate a switch in the transmitter module 25. The carrying handle is shown at 23. The transmitter module in turn will activate the RF transmitter 26. In all of the RF transmitters, the transmission can occur in either the AM or FM wave lengths including short wave lengths or microwave.

At this point in the description it should be pointed out that fire extinguishers are available in many different mountings. They are mounted on walls by way of brackets and they can be mounted in some kind of an enclosure like a glass enclosed cabinet or they can be enclosed in cabinets in a recess in a wall. The front glass door of the enclosure can readily be opened or it can be a sheet of glass that needs to be shattered when an emergency occurs.

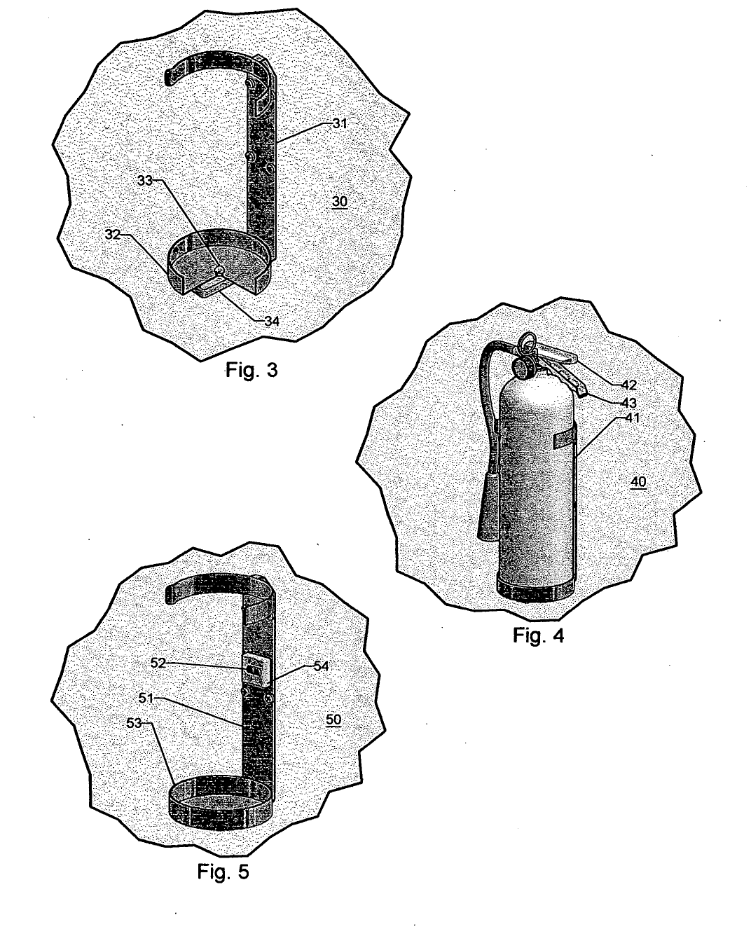

FIG. 3 shows a bracket 31 that is mounted on a wall 30. There is bottom tray-like support 32 which has a spring biased plunger in its center. When the extinguisher is removed from the bottom support, the spring biased plunger activates the transmitter module 34 which in turn will energize the RF transmitter, as was explained above.

FIG. 4 shows the fire extinguisher 41 installed on a wall 40 with its carrying handle 43 and the trigger or operating handle 42 clearly visible.

FIG. 5 again shows a mounting bracket 51 mounted on a wall 50. At 53 is shown the bottom support tray 53. At 52 is shown a sensor element which will receive a signal from a reflector (not shown in this FIG.). When the fire extinguisher 41 of FIG. 4, for example, is removed from the bracket 51, the visible reflector contact is broken or discontinued between the reflector and the sensor element, whereby the sensor element will energize the RF transmitter to transmit the removal of the extinguisher.

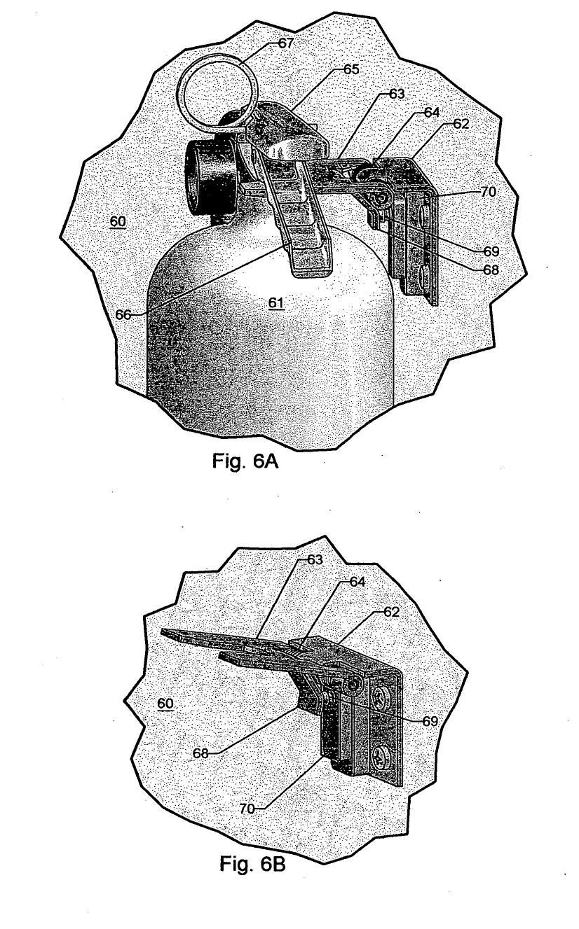

FIGS. 6A and 6B show a different mechanism for signaling the removal of the extinguisher 61 from the wall 60. The extinguisher is mounted on a bracket 62 which has a spring biased hinged flap 63 mounted at its top. The hinged flap 63 is spring biased upwardly by way of a coil spring 64. When the fire extinguisher 61 is placed on top of the flap 63 it is pushed or pivoted downwardly because of the weight of the extinguisher. The safety pin 67 assures that the carrying handle 66 and the operating or trigger handle 65 remain as one unit as long as the safety pin 67 remains in place. In case of fire, the fire extinguisher 61 is removed from the bracket 63 whereby it will move upwardly under the influence of the coil spring 64 to thereby activate the push button 69 by way of the extension 68 which is rigidly connected to the bracket 63. The activation of the push button will energize the transmitter module which in turn will send a signal to a remote monitor or to a proper authority.

If the safety pin 67 is removed to use the extinguisher to douse a fire, the removal will send a signal to the fire department as was explained with reference to FIG. 1, for example.

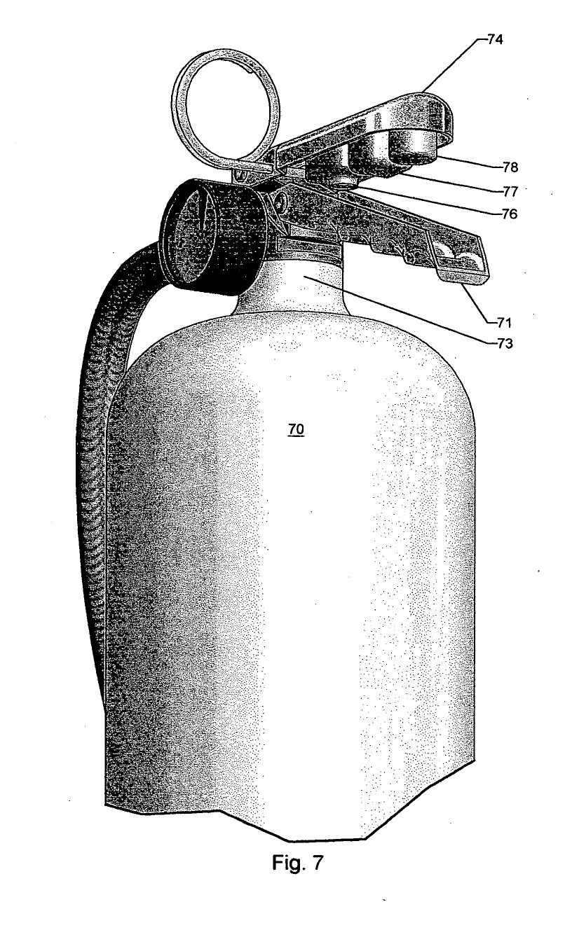

FIG. 7 is a different showing of the use of a reflector-sensing combination. The fire extinguisher 70 has a carrying handle 71 which is attached to a top 73 of the bottle 70. The trigger handle 74 has a sensing unit 76 directly built into it which is connected to a transmitter 77 which will send a signal or alarm to the respective authorities by way of the energy supplied by the battery 78, as was previously explained. When the trigger or operating handle 74 is activated to operate the fire extinguisher, the reflector element, which is located within the carrying handle 71, will approach the sensing unit 76. The sensing unit 76 recognizes the closeness of the reflector element which will set the alarm system in motion. The reflector element can be the bottom of the carrying handle itself because it is made out of metal.

It should be pointed out at this point in the description that limit switches in all of the different embodiments described above can be constructed as ‘normally open’ as well as ‘normally closed’ switches. When dealing with a ‘normally open’ switch, the push button that activates the switch, will merely close a circuit which is instrumental in energizing the RF modules. A ‘normally closed’ switch will disrupt a holding circuit which again will energize the RF transmitter module. It is preferred to use a ‘normally open’ switch because, when it is open, no electricity will flow from the battery to prolong its life cycle. A ‘normally open’ switch is also easier to construct and to maintain.

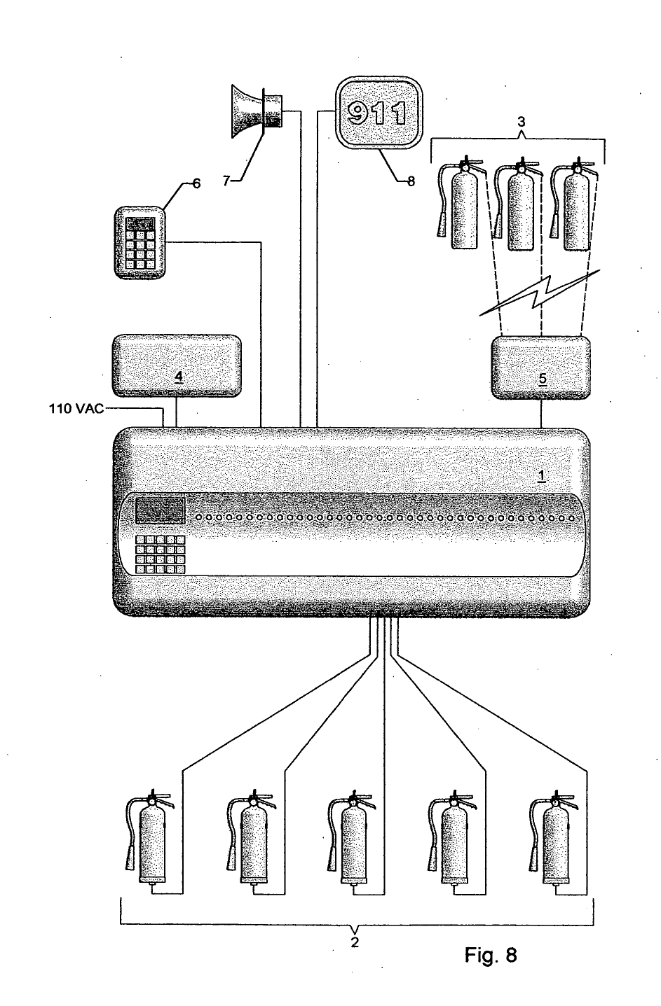

FIG. 8 explains the schematic which is used to monitor a multiple of fire extinguishers being located in multiple of locations throughout a building. The basic monitoring unit is shown at 1. The basic unit 1 monitors a multiple of fire extinguishers 2 as to their presence or removal as was explained above. At 3 is shown a multiple of dire extinguishers that can be monitored individually when a trigger handle is activated to extinguish a fire. The signal that is derived from such activation is sent to the RF transmitter 5. The signal from the transmitter 5 can be relayed to the 911 number 8 or other proper authorities, such as a fire Department, including the activation of an audible alarm 7. In case of a power failure, there is a back-up battery 4.

What I claim is:

1. A fire extinguisher alarm system combination: including a fire extinguisher having a carrying handle thereon and a trigger handle, said trigger handle is normally prevented from operating by the interposition of a safety pin between said carrying handle and said trigger, said fire extinguisher is retained on a support, said support having a sensor at a bottom thereof, said alarm system including means for sensing the movement of said trigger handle in combination with a removal of said fire extinguisher from its bottom support.

2. The alarm system of claim 1, wherein said means for sensing a movement of said trigger handle includes a movement of an element of a switch.

3. The alarm system of claim 2, wherein said switch energizes an RF module.

4. The alarm system of claim 1, wherein said means for sensing a movement of said trigger handle includes a reflector and sensor combination.

5. The alarm system of claim 4, wherein said sensor energizes an RF module.

6. The alarm system of claim 1, wherein said means for sensing a removal of said fire extinguisher includes a contact switch contacting a surface of said fire extinguisher prior to removal.

7. The alarm system of claim 6, wherein said contact switch, when moved out of contact,with said fire extinguisher, energizes a module which creates a signal which is sent to a remote location including a Global Positiong Sytem.

8. The alarm system of claim 7 including a multiple of fire extinguishers located at a multiple of locations.

9. The alarm system of claim 8, wherein each of said multiple of fire extinguishers has a contact switch in contact with each one of said fire extinguishers.

10. The alarm system of claim 9, wherein said contact switch of each of said multiple of fire extinguishers energizes a signal when any one of said multiple of said fire extinguishers is removed from any location.

11. The alarm system of claim 10, wherein said energized signal is sent to a remote monitor including a GPS syytem.

12. The alarm system of claim 8, wherein some of said multiple of fire extinguishers have a reflector and sensor combination switch.

13. The alarm system of claim 12, wherein a visible contact between said reflector and sensor is interrupted when any one of said some of said fire extinguishers is removed from a location.

14. The alarm system of claim 8 including a central monitor which has means for receiving a signal from any one of said multiple of said fire extinguishers.

15. The alarm system of claim 1, wherein a removal of said safety pin activates a switch which in turn energizes an RF transmitter.
